(19) United States
(12) Patent Application Publication
(10) Pub. No.: US 2021/0094544 A1
(43) Pub. Date: Apr. 1, 2021

(54) SUBMERGENCE DATA DETECTION DEVICE, SUBMERGENCE DATA DETECTION METHOD, NON-TRANSITORY STORAGE MEDIUM, SUBMERGENCE DATA PROVISION SYSTEM, AND SUBMERGENCE DATA PROVISION DEVICE

(71) Applicants: AISIN SEIKI KABUSHIKI KAISHA, Kariya-shi (JP); TOYOTA JIDOSHA KABUSHIKI KAISHA, Toyota-shi (JP)

(72) Inventors: Yasushi YAMANE, Kariya-shi (JP); Teruo TATSUMI, Kariya-shi (JP); Kazuhiro KATO, Kariya-shi (JP); Yuhei MORI, Kariya-shi (JP); Hiroshi NOMA, Kariya-shi (JP); Hidetsugu HIGUCHI, Nagoya-shi (JP); Hiromi TONEGAWA, Nagoya-shi (JP); Kenji TSUMURA, Nagoya-shi (JP)

(73) Assignees: AISIN SEIKI KABUSHIKI KAISHA, Kariya-shi (JP); TOYOTA JIDOSHA KABUSHIKI KAISHA, Toyota-shi (JP)

(21) Appl. No.: 17/022,635

(22) Filed: Sep. 16, 2020

(30) Foreign Application Priority Data
Sep. 30, 2019 (JP) 2019-180474

(51) Int. Cl. B60W 30/18; B60W 30/188; B62D 15/02

(52) U.S. Cl. CPC B60W 30/18027; B60W 30/1882; B60W 2555/20; B60W 2552/00; B62D 15/021

(57) ABSTRACT

A submergence data detection device includes a vehicle data acquisition unit configured to acquire vehicle data including at least acceleration data and estimation data for acquiring a drive power value and a traveling resistance value, and a submergence data detection unit configured to detect submergence data based on the vehicle data by a detection method including comparison of a threshold value set according to a calculated value of an acceleration of the vehicle calculated from the drive power value and the traveling resistance value with an actual value of the acceleration, and adjust the detection method according to whether or not a traveling state indicated by the vehicle data corresponds to a first state, in which reliability of the calculated value of the acceleration is degraded, such that detection accuracy of the submergence data in the first state is improved.

### CROSS-REFERENCE TO RELATED APPLICATION

This application claims priority to Japanese Patent Application No. 2019-180474 filed on Sep. 30, 2019, incorporated herein by reference in its entirety.

### BACKGROUND

### 1. Technical Field

The present disclosure relates to a submergence data detection device, a submergence data detection method, a non-transitory storage medium, a submergence data provision system, and a submergence data provision device.

### 2. Description of Related Art

A technique is known that determines whether or not water resistance according to submergence is generated as traveling resistance in consideration of an ideal acceleration, which is a calculated value of an acceleration of a vehicle in an ideal state with no submergence calculated from a drive power value indicating an estimated value of drive power generated from a drive source of the vehicle traveling on a road surface and a traveling resistance value indicating an estimated value of traveling resistance applied to the vehicle, and an actual value of the acceleration of the vehicle, and detects submergence data indicating a state of submergence of the road surface.

### SUMMARY

In the technique described above, the drive power value is an estimated value estimated based on a target value given to the drive source, an opening degree of an accelerator pedal, or the like, and is not an actual value indicating a measurement result of the drive power generated from the drive source. Similarly, the traveling resistance value is not an actual value indicating a measurement result of the traveling resistance applied to the vehicle. Accordingly, in the technique of the related art described above, the estimated value for use in detecting submergence data diverges from the actual value depending on a traveling state of the vehicle, resulting in degradation of detection accuracy of submergence data.

Accordingly, the present disclosure provides a submergence data detection device, a submergence data detection method, a non-transitory storage medium, a submergence data provision system, and a submergence data provision device capable of obtaining submergence data with high accuracy.

A first aspect of the present disclosure relates to a submergence data detection device. The submergence data detection device includes a vehicle data acquisition unit and a submergence data detection unit. The vehicle data acquisition unit is configured to acquire vehicle data. The vehicle data includes at least acceleration data indicating an actual value of an acceleration of a vehicle traveling on a road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle. The submergence data detection unit is configured to detect submergence data indicating a state of submergence of the road surface, on which the vehicle travels, based on the vehicle data by a detection method including comparison of a threshold value set according to a calculated value of the acceleration of the vehicle calculated from the drive power value and the traveling resistance value with the actual value of the acceleration of the vehicle. The submergence data detection unit is configured to adjust the detection method according to whether or not the traveling state indicated by the vehicle data corresponds to a first state, in which reliability of the calculated value of the acceleration of the vehicle is degraded, such that detection accuracy of the submergence data in the first state is improved.

With the submergence data detection device, the submergence data is detected by the detection method appropriately adjusted according to the traveling state of the vehicle such that the detection accuracy of the submergence data is improved, whereby it is possible to obtain submergence data with high accuracy.

In the submergence data detection device, the vehicle data acquisition unit may be configured to acquire, as the vehicle data to be a criterion for determining whether or not the traveling state corresponds to the first state, determination data including at least one of a feature of the road surface, a change amount per predetermined time of the acceleration, an operation state of the drive source, a steering angle of the vehicle, air pressure of wheels of the vehicle, weather, and a weight of the vehicle. The submergence data detection unit may be configured to determine whether or not the traveling state corresponds to the first state based on the determination data. According to such a configuration, focusing on the determination data related to a factor causing divergence between the actual value of the drive power and the drive power value or divergence between the actual value of the traveling resistance and the traveling resistance value, it is possible to appropriately perform determination regarding whether or not the reliability of the calculated value of the acceleration of the vehicle is degraded.

In this case, the vehicle data acquisition unit may be configured to acquire, as the determination data, at least data indicating the change amount per predetermined time of the acceleration. The submergence data detection unit may be configured to determine that the traveling state corresponds to the first state when the change amount is greater than a predetermined amount and adjust the detection method so as to suppress divergence between an actual value of the drive power and the drive power value according to a determination result. According to such a configuration, focusing on the change amount per predetermined time of the acceleration related to the factor causing the divergence between the actual value of the drive power and the drive power value, it is possible to appropriately perform determination regarding whether or not the reliability of the calculated value of the acceleration of the vehicle is degraded, and to appropriately suppress the divergence between the actual value of the drive power and the drive power value.

When the determination data is acquired, the vehicle data acquisition unit may be configured to acquire, as the determination data, at least data indicating the steering angle of the vehicle. The submergence data detection unit may be configured to determine that the traveling state corresponds to the first state when the steering angle of the vehicle is greater than a predetermined angle and adjust the detection method so as to suppress divergence between an actual value of the traveling resistance and the traveling resistance value according to a determination result. According to such a configuration, focusing on the steering angle of the vehicle related to the factor causing the divergence between the actual value of the traveling resistance and the traveling resistance value, it is possible to appropriately perform determination regarding whether or not the reliability of the calculated value of the acceleration of the vehicle is degraded, and to appropriately suppress the divergence between the actual value of the traveling resistance and the traveling resistance value.

In the submergence data detection device, the submergence data detection unit may be configured to adjust the detection method by correcting at least one value of the traveling resistance value and the drive power value when the traveling state corresponds to the first state. According to such a configuration, at least one of the traveling resistance value and the drive power value to be a source of the calculated value of the acceleration for setting the threshold value for comparison with the actual value of the acceleration is corrected, whereby it is possible to easily adjust the detection method such that the detection accuracy of the submergence data is improved.

In the submergence data detection device, the submergence data detection unit may be configured to adjust the detection method by changing a setting method of the threshold value for comparison with the actual value of the acceleration of the vehicle when the traveling state corresponds to the first state. According to such a configuration, the setting method of the threshold value for comparison with the actual value of the acceleration is changed, whereby it is possible to easily adjust the detection method such that the detection accuracy of the submergence data is improved.

In the submergence data detection device, the submergence data detection unit may be configured to, when the submergence data is detected by the detection method including the comparison of a plurality of threshold values set according to a plurality of calculated values of the acceleration with a plurality of actual values of the acceleration, adjust the detection method by setting an influence on the detection of the submergence data of the traveling resistance value and the drive power value calculated when the traveling state corresponds to the first state to be smaller than an influence on the detection of the submergence data of the traveling resistance value and the drive power value calculated when the traveling state corresponds to a second state different from the first state. According to such a configuration, the influence of data with low reliability among a plurality of pieces of data to be a source of a plurality of calculated values of the acceleration on the detection of the submergence data is set to be smaller, whereby it is possible to easily adjust the detection method such that the detection accuracy of the submergence data is improved.

A second aspect of the present disclosure relates to a submergence data detection method. The submergence data detection method includes acquiring vehicle data. The vehicle data includes at least acceleration data indicating an actual value of an acceleration of a vehicle traveling on a road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle. The submergence data detection method also includes detecting submergence data indicating a state of submergence of the road surface, on which the vehicle travels, based on the vehicle data by a detection method including comparison of a threshold value set according to a calculated value of the acceleration of the vehicle calculated from the drive power value and the traveling resistance value with the actual value of the acceleration of the vehicle. The submergence data detection method also includes adjusting the detection method according to whether or not the traveling state indicated by the vehicle data corresponds to a first state, in which reliability of the calculated value of the acceleration of the vehicle is degraded, such that detection accuracy of the submergence data in the first state is improved.

With the submergence data detection method, the submergence data is detected by the detection method appropriately adjusted according to the traveling state of the vehicle such that the detection accuracy of the submergence data is improved, whereby it is possible to obtain submergence data with high accuracy.

A third aspect of the present disclosure relates to a non-transitory storage medium storing instructions that are executable by one or more processors and that cause the one or more processors to perform functions including acquiring vehicle data. The vehicle data includes at least acceleration data indicating an actual value of an acceleration of a vehicle traveling on a road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle. The functions also include detecting submergence data indicating a state of submergence of the road surface, on which the vehicle travels, based on the vehicle data by a detection method including comparison of a threshold value set according to a calculated value of the acceleration of the vehicle calculated from the drive power value and the traveling resistance value with the actual value of the acceleration of the vehicle. The functions also include adjusting the detection method according to whether or not the traveling state indicated by the vehicle data corresponds to a first state, in which reliability of the calculated value of the acceleration of the vehicle is degraded, such that detection accuracy of the submergence data in the first state is improved.

With the non-transitory storage medium, the submergence data is detected by the detection method appropriately adjusted according to the traveling state of the vehicle such that the detection accuracy of the submergence data is improved, whereby it is possible to obtain submergence data with high accuracy.

A fourth aspect of the present disclosure relates to a submergence data provision system. The submergence data provision system includes a vehicle data acquisition unit, a submergence data detection unit, and a submergence data provision unit. The vehicle data acquisition unit is configured to acquire vehicle data. The vehicle data includes at least acceleration data indicating an actual value of an acceleration of a vehicle traveling on a road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle. The submergence data detection unit is configured to detect submergence data indicating a state of submergence of the road surface, on which the vehicle travels, based on the vehicle data by a detection method including comparison of a threshold value set according to a calculated value of the acceleration of the vehicle calculated from the drive power value and the traveling resistance value with the actual value of the acceleration of the vehicle. The submergence data detection unit is configured to adjust the detection method according to whether or not the traveling state indicated by the vehicle data corresponds to a first state, in which reliability of the calculated value of the acceleration of the vehicle is degraded, such that detection accuracy of the submergence data in the first state is improved. The submergence data provision unit is configured to provide the submergence data detected by the submergence data detection unit to the outside.

With the submergence data provision system, the submergence data is detected by the detection method appropriately adjusted according to the traveling state of the vehicle such that the detection accuracy of the submergence data is improved, whereby it is possible to obtain submergence data with high accuracy. Then, it is possible to provide the submergence data with high accuracy to the outside.

In the submergence data provision system, the vehicle data acquisition unit may be configured to acquire the vehicle data along with position data indicating a position of the vehicle on the road surface corresponding to the vehicle data. The submergence data detection unit may be configured to detect the submergence data while associating the submergence data with the position data. The submergence data provision unit may be configured to provide the submergence data classified for each region on the road surface according to the position data. According to such a configuration, it is possible to provide the submergence data with high accuracy appropriately classified according to the position data to the outside.

In the submergence data provision system, the vehicle data acquisition unit may be configured to acquire the vehicle data along with position data indicating a position of the vehicle on the road surface corresponding to the vehicle data. The submergence data detection unit may be configured to detect the submergence data classified for each region on the road surface based on the vehicle data classified for each region on the road surface according to the position data. The submergence data provision unit may be configured to provide the submergence data classified for each region on the road surface. With such a configuration, it is also possible to provide the submergence data with high accuracy appropriately classified according to the position data to the outside.

A fifth aspect of the present disclosure relates to a submergence data provision device. The submergence data provision device includes a submergence data acquisition unit and a submergence data provision unit. The submergence data acquisition unit is configured to acquire submergence data detected by a submergence data detection unit. The submergence data detection unit is configured to detect the submergence data indicating a state of submergence of a road surface, on which a vehicle travels, based on vehicle data by a detection method. The vehicle data includes at least acceleration data indicating an actual value of an acceleration of the vehicle traveling on the road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle. The detection method includes comparison of a threshold value set according to a calculated value of the acceleration of the vehicle calculated from the drive power value and the traveling resistance value with the actual value of the acceleration of the vehicle. The submergence data detection unit is configured to adjust the detection method according to whether or not the traveling state indicated by the vehicle data corresponds to a first state, in which reliability of the calculated value of the acceleration of the vehicle is degraded, such that detection accuracy of the submergence data in the first state is improved. The submergence data provision unit is configured to provide the submergence data acquired by the submergence data acquisition unit to the outside.

With the submergence data provision device, it is possible to obtain the submergence data with high accuracy detected by the detection method appropriately adjusted according to the traveling state of the vehicle such that the detection accuracy of the submergence data is improved. Then, it is possible to provide the submergence data with high accuracy to the outside.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an exemplary and schematic block diagram illustrating a flow of data in a submergence data provision system according to a first embodiment;

FIG. 2 is an exemplary and schematic block diagram showing functions of a vehicle and a server device according to the first embodiment;

FIG. 3 is an exemplary and schematic diagram illustrating an example of correction of a drive power value that can be executed in the first embodiment;

FIG. 4 is an exemplary and schematic diagram illustrating an example, different from FIG. 3, of correction of the drive power value that can be executed in the first embodiment;

FIG. 5 is an exemplary and schematic diagram illustrating an example of correction of a traveling resistance value that can be executed in the first embodiment;

FIG. 6 is an exemplary and schematic diagram illustrating an example of change of a determination acceleration that can be executed in the first embodiment;

FIG. 7 is an exemplary and schematic diagram illustrating an example of selection of data for use in detecting submergence data that can be executed in the first embodiment;

FIG. 8 is an exemplary flowchart showing an example of a series of processing that can be executed to detect submergence data according to the first embodiment;

FIG. 9 is an exemplary flowchart showing an example, different from FIG. 8, of a series of processing that can be executed to detect submergence data according to the first embodiment;

FIG. 10 is an exemplary flowchart showing an example, different from FIGS. 8 and 9, of a series of processing that can be executed to detect submergence data according to the first embodiment;

FIG. 11 is an exemplary and schematic block diagram illustrating a flow of data in a submergence data provision system according to a second embodiment;

FIG. 12 is an exemplary and schematic block diagram showing functions of a vehicle and a server device according to the second embodiment;

FIG. 13 is an exemplary and schematic block diagram illustrating a flow of data in a submergence data provision system according to a third embodiment;

FIG. 14 is an exemplary and schematic block diagram showing functions of a vehicle, a first server device, and a second server device according to the third embodiment;

FIG. 15 is an exemplary and schematic block diagram illustrating a flow of data in a submergence data provision system according to a fourth embodiment; and

FIG. 16 is an exemplary and schematic block diagram showing the hardware configuration of an information processing device that can be used in the submergence data provision system according to the first to fourth embodiments.

### DETAILED DESCRIPTION OF EMBODIMENTS

Hereinafter, several embodiments of the present disclosure will be described referring to the drawings. The configurations of the following embodiments and operations and effects achieved by the configurations are merely exemplary, and are not limited to the following description.

A technique is known that determines whether or not water resistance according to submergence is generated as traveling resistance in consideration of an ideal acceleration, which is a calculated value of an acceleration of a vehicle in an ideal state with no submergence calculated from a drive power value indicating an estimated value of drive power generated from a drive source of the vehicle traveling on a road surface and a traveling resistance value indicating an estimated value of traveling resistance applied to the vehicle, and an actual value of the acceleration of the vehicle, and detects submergence data indicating a state of submergence of the road surface.

In the technique described above, the drive power value is an estimated value estimated based on a target value given to the drive source, an opening degree of an accelerator pedal, or the like, and is not an actual value indicating a measurement result of the drive power generated from the drive source. Similarly, the traveling resistance value is not an actual value indicating a measurement result of the traveling resistance applied to the vehicle. Accordingly, in the technique of the related art described above, the estimated value for use in detecting submergence data diverges from the actual value depending on a traveling state of the vehicle, resulting in degradation of detection accuracy of submergence data.

Accordingly, the present disclosure suggests several embodiments capable of obtaining submergence data with high accuracy.

### First Embodiment

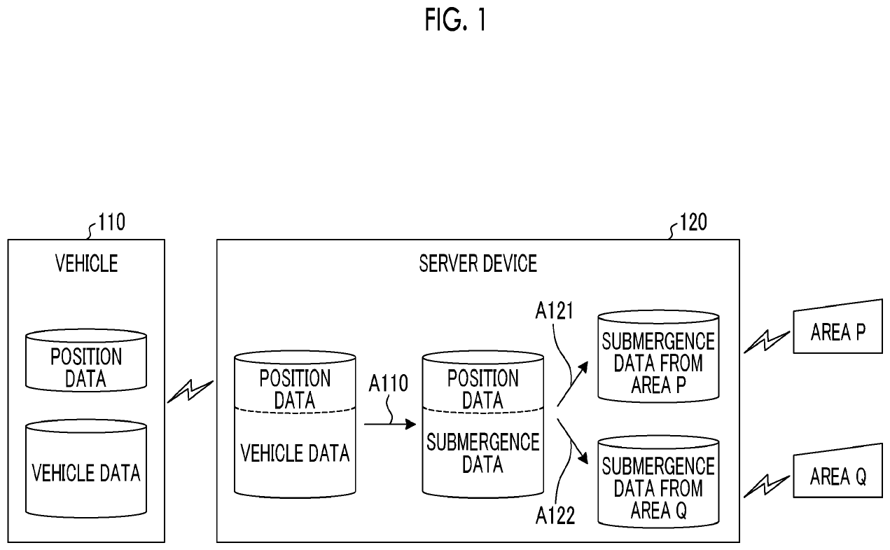

FIG. 1 is an exemplary and schematic block diagram illustrating a flow of data in a submergence data provision system according to a first embodiment.

As shown in FIG. 1, the submergence data provision system according to the first embodiment includes a vehicle 110 and a server device 120. The server device 120 is an example of a “submergence data detection device”, and is an example of a “submergence data provision device”.

The vehicle 110 is a so-called networked vehicle having a communication function of transmitting vehicle data indicating a traveling state of the vehicle 110 to the server device 120 along with position data indicating a position of the vehicle 110 on a road surface. The vehicle 110 is constituted as, for example, a hybrid vehicle having both of an internal combustion engine and an electric motor as a drive source. Note that the technique of the first embodiment can be applied to a case where the vehicle 110 is constituted as an electric vehicle having solely an electric motor as a drive source and a case where the vehicle 110 is constituted as an internal combustion engine type vehicle having solely an internal combustion engine as a drive source.

The position data is acquired by, for example, a global navigation satellite system (GNSS), such as a global positioning system (GPS), an odometry, or the like. The vehicle data includes, for example, internal data internally acquired by various sensors mounted in the vehicle 110, such as an actual value of an acceleration of the vehicle 110, and external data externally acquired from the outside by the communication function of the vehicle 110.

More specifically, the vehicle data includes at least acceleration data indicating the actual value of the acceleration of the vehicle 110 and estimation data for estimating a drive power value indicating drive power generated from the drive source of the vehicle 110 and a traveling resistance value indicating traveling resistance applied to the vehicle 110. The estimation data for estimating the drive power value is, for example, a target value given to the drive source, an opening degree of an accelerator pedal, or the like. The estimation data for estimating the traveling resistance value is, for example, various coefficients and parameters for calculating an estimated value of frictional resistance, air resistance, grade resistance, or the like.

With the vehicle data described above, it is possible to perform determination regarding whether or not water resistance according to submergence is generated as traveling resistance based on comparison of a determination acceleration as a threshold value set according to an ideal acceleration calculated from the drive power value and the traveling resistance value of the vehicle 110 with the actual value of the acceleration of the vehicle 110, and to detect submergence data indicating a state of submergence of the road surface. More specifically, for example, when the actual value of the vehicle acceleration is greater than the determination acceleration, determination is made that submergence occurs. Accordingly, in the first embodiment, the server device 120 detects the submergence data based on the vehicle data received from the vehicle 110 (see an arrow A110) The submergence data may be calculated as a submergence amount (submergence depth) based on not only the occurrence of submergence as a submergence state but also, for example, deviation between the actual value of the vehicle acceleration and the ideal acceleration or a level of a submergence amount is determined in advance and the submergence data may be calculated as a level value representing the level.

Here, as described above, the vehicle 110 transmits the vehicle data along with the position data. Accordingly, the server device 120 associates the position data with the vehicle data, and also associates the position data with the submergence data detected from the vehicle data. With this, the server device 120 can classify the detected submergence data for each position on the road surface, more specifically, for each area (see arrows A121 and A122). Then, the server device 120 provides the classified submergence data to the outside, such as a company of a corresponding area or another vehicle of a corresponding area.

In the example shown in FIG. 1, although solely two areas P and Q are shown as areas where the submergence data is provided, in the first embodiment, the number of areas where the submergence data is provided may be one or may be three or more. In the first embodiment, the server device 120 may collect vehicle data (and position data) from a plurality of vehicles 110.

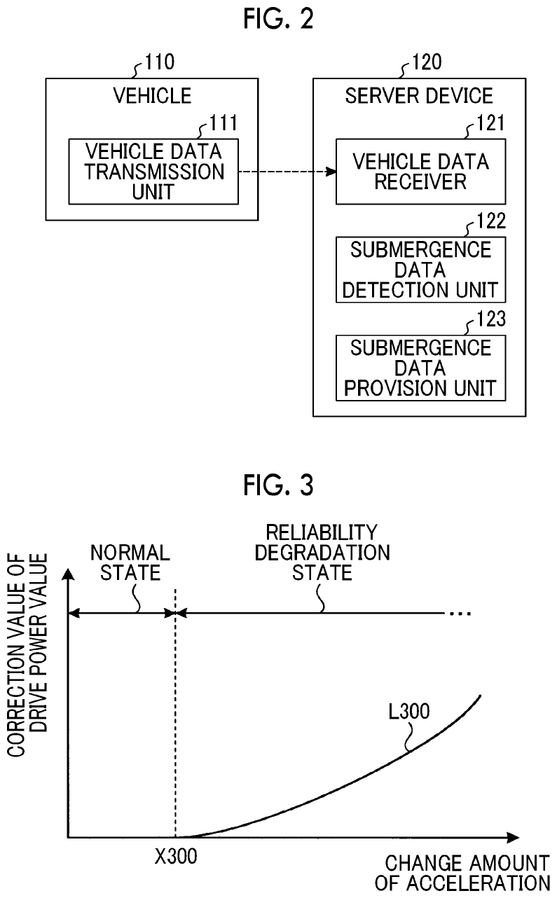

A flow of data described above can be implemented by providing functions shown in subsequent FIG. 2 in the vehicle 110 and the server device 120.

FIG. 2 is an exemplary and schematic block diagram showing functions of the vehicle 110 and the server device 120 according to the first embodiment.

As shown in FIG. 2, the vehicle 110 includes a vehicle data transmission unit 111, and the server device 120 includes a vehicle data receiver 121, a submergence data detection unit 122, and a submergence data provision unit 123. The vehicle data receiver 121 is an example of a “vehicle data acquisition unit”, and the submergence data detection unit 122 is an example of a “submergence data acquisition unit”.

The vehicle data transmission unit 111 transmits the vehicle data to the server device 120 along with the position data. The vehicle data and the position data are transmitted at predetermined intervals, for example, at intervals of hundreds of ms. Alternatively, when a condition determined in advance is established or when there is a request from the outside of the vehicle, the vehicle data and the position data may be transmitted.

Then, the vehicle data receiver 121 receives the vehicle data and the position data transmitted from the vehicle data transmission unit 111. Then, the submergence data detection unit 122 detects the submergence data by the above-described detection method including comparison of the determination acceleration set according to the ideal acceleration calculated from the drive power value and the traveling resistance value of the vehicle 110 with the actual value of the acceleration of the vehicle 110. Then, the submergence data provision unit 123 classifies the submergence data according to the position data, and then, provides the submergence data to the outside.

Incidentally, as described above, the estimated value for use in detecting the submergence data diverges from the actual value depending on the traveling state of the vehicle 110, resulting in degradation of detection accuracy of submergence.

Accordingly, in the first embodiment, the submergence data detection unit 122 executes adjustment of the detection method according to whether or not the traveling state indicated by the vehicle data corresponds to a reliability degradation state, in which reliability of (at least one of the traveling resistance value and the drive power value to be a source of) the ideal acceleration is degraded, such that the detection accuracy of the submergence data in the reliability degradation state is improved.

For example, the reliability degradation state is likely to occur depending on a feature of the road surface, on which the vehicle 110 travels. More specifically, on a road surface on which the vehicle is likely to slip due to snow coverage or freezing and an uneven road surface, such as a gravel road, divergence between the estimated value and the actual value of the traveling resistance is likely to occur. When a G sensor that can detect an acceleration in a front-rear direction of the vehicle 110 including an influence of a gravitational acceleration resulting from a grade of a road surface is not used, the divergence between the estimated value and the actual value of the traveling resistance is likely to occur even on a road surface with a grade.

When an acceleration command given to the vehicle 110 becomes suddenly large to cause a change amount per predetermined time of the acceleration of the vehicle 110 to be greater than a predetermined amount, divergence between the estimated value and the actual value of the drive power is likely to become large, and the reliability degradation state is likely to occur. For example, when the acceleration command becomes suddenly large, the estimated value of the drive power is a calculated value and is likely to be immediately followed up; however, the actual value of the drive power is hardly immediately followed up due to an influence of response delay. For this reason, the reliability degradation state is likely to occur.

Similarly, from a viewpoint of response delay, in all operation states of the drive source of the vehicle 110, the divergence between the estimated value and the actual value of the drive power is likely to become large, and the reliability degradation state is likely to occur. For example, an internal combustion engine as one drive source is likely to have response delay of the drive power greater than an electric motor as another drive source. For this reason, when the vehicle 110 is constituted as a hybrid vehicle having both of an internal combustion engine and an electric motor as a drive source, the reliability degradation state is likely to occur depending on the operation state of the electric motor. While the operation state of the drive source of the vehicle 110 changes with switching of a traveling mode including an economy mode, a sports mode, and the like, the degree of response delay of the drive power is different for each traveling mode. For this reason, the reliability degradation state is likely to occur depending on the traveling mode.

During turning of the vehicle 110, the divergence between the estimated value and the actual value of the traveling resistance applied to the vehicle 110 is likely to become large. Accordingly, the reliability degradation state is likely to occur depending on the steering angle of the vehicle 110.

When air pressure of wheels of the vehicle 110 is low, when the vehicle 110 travels under weather that strong wind blows, when a weight of the vehicle 110 is different from a normal state due to package loading, the presence or absence of traction, or the like, or the like, the divergence between the estimated value and the actual value of the traveling resistance is likely to occur, and the reliability degradation state is likely to occur.

Accordingly, the first embodiment includes, in the vehicle data, at least one of the feature of the road surface, the change amount per predetermined time of the acceleration, the operation state of the drive source, the steering angle of the vehicle 110, the air pressure of the wheels of the vehicle 110, weather, and the weight of the vehicle 110 as the determination data to be a criterion for determining whether or not the traveling state corresponds to a first state. Then, the submergence data detection unit 122 determines whether or not the traveling state of the vehicle 110 corresponds to the reliability degradation state based on the determination data, and executes the adjustment of the detection method according to a determination result such that the detection accuracy of the submergence data in the reliability degradation state is improved.

The adjustment of the detection method is executed by, for example, one of the following first to third methods.

First Method

A first method is a method shown in FIGS. 3 to 5 that adjusts the detection method of the submergence data by correcting at least one of the drive power value and the traveling resistance value estimated based on the vehicle data.

FIG. 3 is an exemplary and schematic diagram illustrating an example of correction of the drive power value that can be executed in the first embodiment.

In the example shown in FIG. 3, the submergence data detection unit 122 determines whether or not the traveling state of the vehicle 110 corresponds to the reliability degradation state based on the change amount (per predetermined time) of the acceleration as one of the determination data. Then, the submergence data detection unit 122 corrects the drive power value according to a determination result, and adjusts the detection method of the submergence data such that the drive power value after correction is used in calculating an ideal acceleration to be a criterion for setting a determination acceleration for comparison with the actual value of the acceleration.

More specifically, in the example shown in FIG. 3, the submergence data detection unit 122 determines that the traveling state of the vehicle 110 corresponds to a normal state different from the reliability degradation state when the change amount of the acceleration is equal to or less than a predetermined amount X300, and determines that the traveling state of the vehicle 110 corresponds to the reliability degradation state when the change amount of the acceleration is greater than the predetermined amount X300. Then, the submergence data detection unit 122 does not carry out the correction of the drive power value for use in detecting the submergence data when determination is made that the traveling state of the vehicle 110 corresponds to the normal state, and corrects the drive power value for use in detecting the submergence data in compliance with a map set in advance indicated by a solid line L300 when determination is made that the traveling state of the vehicle 110 corresponds to the reliability degradation state.

As shown in FIG. 3, the map indicated by the solid line L300 is set in advance such that a greater correction value is acquired as the change amount of the acceleration is greater. With such a setting, it is possible to appropriately correct the divergence between the estimated value and the actual value of the drive power that is likely to become greater as the change amount of the acceleration of the vehicle 110 becomes greater.

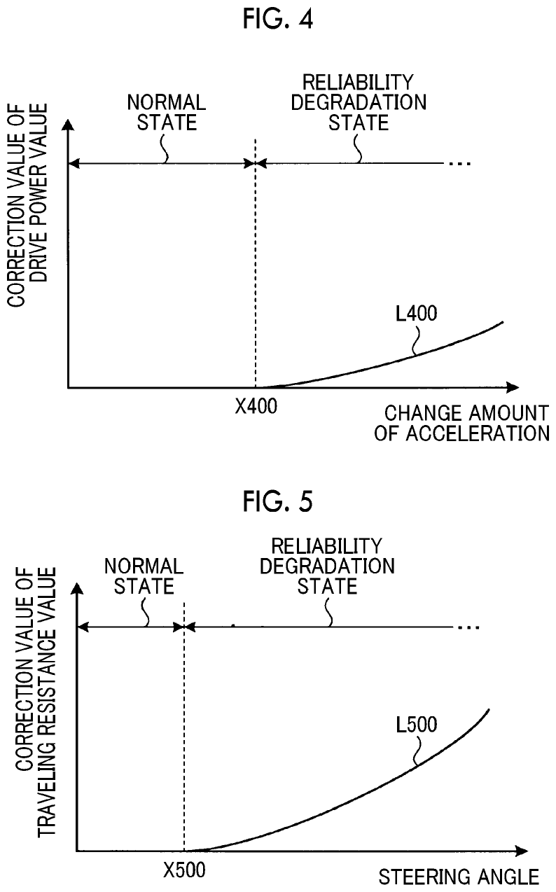

Incidentally, as described above, likelihood of the occurrence of the divergence between the estimated value and the actual value of the drive power is different depending on the operation state of the drive source of the vehicle 110. Accordingly, assuming that the example shown in FIG. 3 shows the correction of the drive power value that can be executed in an operation state in which the divergence between the estimated value and the actual value of the drive power is likely to occur, correction of the drive power value in an operation state in which the divergence between the estimated value and the actual value of the drive power hardly occurs is as in an example shown in subsequent FIG. 4.

FIG. 4 is an exemplary and schematic diagram illustrating an example, different from FIG. 3, of correction of the drive power value that can be executed in the first embodiment.

In the example shown in FIG. 4, as in the example shown in FIG. 3, the submergence data detection unit 122 determines whether or not the traveling state of the vehicle 110 corresponds to the reliability degradation state based on the change amount (per predetermined time) of the acceleration as one of the determination data, and corrects the drive power value according to a determination result.

More specifically, in the example shown in FIG. 4, the submergence data detection unit 122 determines that the traveling state of the vehicle 110 corresponds to the normal state when the change amount of the acceleration is equal to or less than a predetermined amount X400, and determines that the traveling state of the vehicle 110 corresponds to the reliability degradation state when the change amount of the acceleration is greater than the predetermined amount X400. Then, the submergence data detection unit 122 does not carry out the correction of the drive power value for use in detecting the submergence data when determination is made that the traveling state of the vehicle 110 corresponds to the normal state, and corrects the drive power value for use in detecting the submergence data in compliance with a map set in advance indicated by a solid line L400 when determination is made that the traveling state of the vehicle 110 corresponds to the reliability degradation state. More specifically, the submergence data detection unit 122 calculates, for example, a value obtained by subtracting a correction value obtained from the map from the calculated drive power value as the drive power value after correction, calculates the ideal acceleration using the drive power value after correction, and detects the submergence data.

As will be understood in comparison between the example shown in FIG. 3 and the example shown in FIG. 4, the predetermined amount X400 in the example shown in FIG. 4 is greater than the predetermined amount X300 in the example shown in FIG. 3. The map indicated by the solid line L400 in the example shown in FIG. 4 is smaller in a degree of increase of the correction value with an increase in the change amount of the acceleration than the map indicated by the solid line L300 in the example shown in FIG. 3. The facts match a premise that the example shown in FIG. 3 shows the correction of the drive power value that can be corrected in the operation state in which the divergence between the estimated value and the actual value of the drive power is likely to occur, and the example shown in FIG. 4 shows the correction of the drive power value that can be executed in the operation state in which the divergence between the estimated value and the actual value of the drive power hardly occurs.

Here, both of the examples shown in FIGS. 3 and 4 are an example where the adjustment of the detection method of the submergence data is executed by the correction of the drive power value. This is because the change amount of the acceleration and the operation state of the drive source as the determination data considered in the examples shown in FIGS. 3 and 4 are data related to the factor causing the divergence between the estimated value and the actual value of the drive power as described above.

Note that, as described above, the determination data can also include the feature of the road surface, the steering angle of the vehicle 110, the air pressure of the wheels of the vehicle 110, weather, and the weight of the vehicle 110. As described above, all of the five pieces of determination data are data related to the factor causing the divergence between the estimated value and the actual value of the traveling resistance. Accordingly, in order to improve the detection accuracy of the submergence data when at least one of the five pieces of determination data indicates the reliability degradation state, as shown in subsequent FIG. 5, it is desirable to correct the traveling resistance value instead of the drive power value.

FIG. 5 is an exemplary and schematic diagram illustrating an example of correction of the traveling resistance value that can be executed in the first embodiment.

In the example shown in FIG. 5, the submergence data detection unit 122 determines whether or not the traveling state of the vehicle 110 corresponds to the reliability degradation state based on the steering angle as one of the determination data, and corrects the traveling resistance value according to a determination result.

More specifically, in the example shown in FIG. 5, the submergence data detection unit 122 determines that the traveling state of the vehicle 110 corresponds to the normal state when the steering angle is equal to or less than a predetermined amount X500, and determines that the traveling state of the vehicle 110 corresponds to the reliability degradation state when the change amount of the acceleration is greater than the predetermined amount X500. Then, the submergence data detection unit 122 does not carry out the correction of the traveling resistance value for use in detecting the submergence data when determination is made that the traveling state of the vehicle 110 corresponds to the normal state, and corrects the traveling resistance value for use in detecting the submergence data in compliance with a map set in advance indicated by a solid line L500 when determination is made that the traveling state of the vehicle 110 corresponds to the reliability degradation state. More specifically, the submergence data detection unit 122 calculates, for example, a value obtained by adding a correction value obtained from the map to the calculated traveling resistance value as the traveling resistance value as correction, calculates an ideal acceleration using the traveling resistance value after correction, and detects the submergence data.

As shown in FIG. 5, the map indicated by the solid line L500 is set such that the greater correction value is acquired as a change amount of the steering angle is greater. With such a setting, it is possible to appropriately correct the divergence between the estimated value and the actual value of the traveling resistance that is likely to become greater as the steering angle becomes greater.

Although the example shown in FIG. 5 shows the correction of the traveling resistance value according to the steering angle, in the first embodiment, the correction of the traveling resistance value according to the feature of the road surface, the air pressure of the wheels of the vehicle 110, weather, or the weight of the vehicle 110 is also executed as in the example shown in FIG. 5. In the first embodiment, both of the drive power value and the traveling resistance value, instead of solely one of the drive power value and the traveling resistance value, can be corrected.

Second Method

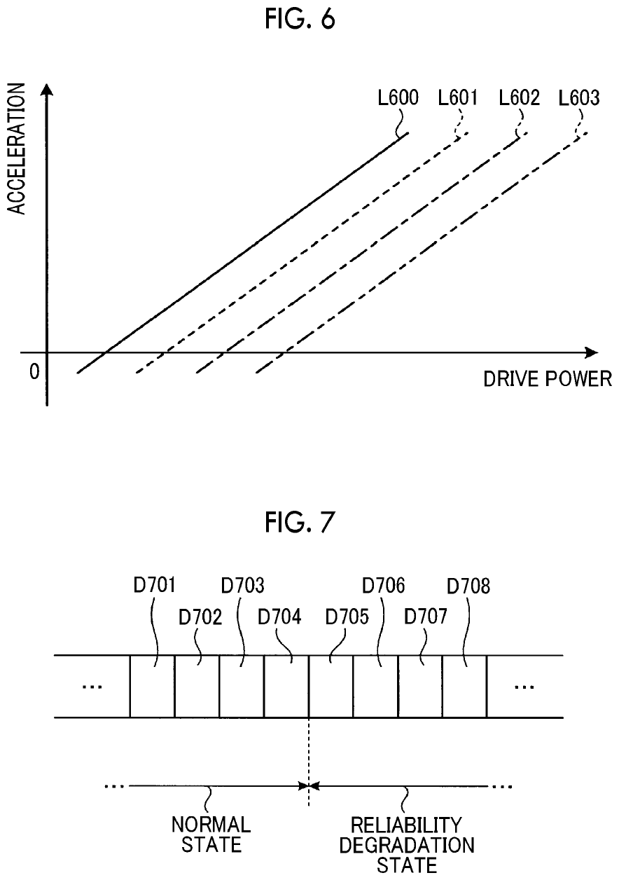

A second method is a method shown in subsequent FIG. 6 that adjusts the detection method of the submergence data by basically using the drive power value and the traveling resistance value estimated based on the vehicle data without correction and changing the setting method of the determination acceleration as a threshold value for comparison with the actual value of the acceleration.

FIG. 6 is an exemplary and schematic diagram illustrating an example of change of the determination acceleration that can be executed in the first embodiment.

In the example shown in FIG. 6, a solid line L600 corresponds to an ideal acceleration calculated from the drive power value and the traveling resistance value estimated based on the vehicle data, and a broken line L601 corresponds to a determination acceleration set according to an ideal acceleration when determination is made that the traveling state of the vehicle 110 corresponds to the normal state. In the example shown in FIG. 6, a one-dot chain line L602 and a two-dot chain line L603 correspond to a determination acceleration set according to an ideal acceleration when determination is made that the traveling state of the vehicle 110 corresponds to the reliability degradation state.

When submergence occurs on the road surface, the acceleration to be obtained is supposed to be small due to water resistance even though the same drive power as when submergence does not occur is generated. Accordingly, as shown in FIG. 6, in the first embodiment, the submergence data detection unit 122 sets the determination acceleration (see the broken line L601, the one-dot chain line L602, and the two-dot chain line L603) to be smaller than the ideal acceleration (see the solid line L600) calculated from the drive power value and the traveling resistance value estimated based on the vehicle data.

Note that, in the reliability degradation state, as described above, the divergence between the estimated value and the actual value of the drive power and the divergence between the estimated value and the actual value of the traveling resistance become greater than in the normal state. For example, in the reliability degradation state, the actual value of the drive power becomes smaller than the estimated value of the drive power or the actual value of the traveling resistance becomes greater than the estimated value of the traveling resistance. Accordingly, in the first embodiment, the submergence data detection unit 122 sets the determination acceleration (see the one-dot chain line L602 and the two-dot chain line L603) in the reliability degradation state to be smaller than the determination acceleration (see the broken line L601) in the normal state so as to absorb the influence of the divergence generated in the reliability degradation state on the detection of the submergence data.

The change of the determination acceleration described above needs to be executed at a greater level as the degree of the reliability degradation state becomes greater, that is, the divergence between the estimated value and the actual value of the drive power and the divergence between the estimated value and the actual value of the traveling resistance become greater. Accordingly, in the first embodiment, the submergence data detection unit 122 adjusts how much the determination acceleration is set to be smaller than the ideal acceleration according to the degree of divergence in the reliability degradation state, for example, how much the change amount of the acceleration exceeds the predetermined amount, how much the steering angle exceeds the predetermined angle, or the like. Accordingly, for example, in the example shown in FIG. 6, it can be said that the divergence in the reliability degradation state in which the determination acceleration corresponding to the two-dot chain line L603 is set is smaller than the divergence in the reliability degradation state in which the determination acceleration corresponding to the one-dot chain line L602 is set.

Third Method

A third method is a method shown in subsequent FIG. 7 that, when comparison between the determination acceleration and the actual value of the acceleration is executed using a plurality of pieces of data, selects data for use in detecting the submergence data among the pieces of data according to the traveling state of the vehicle 110.

FIG. 7 is an exemplary and schematic diagram illustrating an example of selection of data for use in detecting the submergence data that can be executed in the first embodiment.

In the example shown in FIG. 7, blocks D701 to D708 indicate a set of data, such as the drive power value, the traveling resistance value, and the actual value of the acceleration, for use in detecting the submergence data.

Again, in the reliability degradation state, the divergence between the estimated value and the actual value of the drive power and the divergence between the estimated value and the actual value of the traveling resistance become greater than in the normal state. Accordingly, when the submergence data is detected using a plurality of pieces of data, in a case where the pieces of data includes data acquired in the reliability degradation state, the detection accuracy of the submergence data is degraded. Therefore, in the first embodiment, in a case where the submergence data is detected using a plurality of pieces of data, the submergence data detection unit 122 sets the influence of the traveling resistance value and the drive power value calculated from data corresponding to the reliability degradation state on the detection of the submergence data to be smaller than the influence of the traveling resistance value and the drive power value calculated from data corresponding to the normal state on the detection of the submergence data, thereby executing the adjustment of the detection method.

For example, in the example shown in FIG. 7, assuming that a plurality of pieces of data before the block D704 corresponds to the normal state, and a plurality of pieces of data after the block D705 corresponds to the reliability degradation state, the submergence data detection unit 122 excludes the pieces of data after the block D705 from data for use in detecting the submergence data, and uses solely the pieces of data before the block D704 in detecting the submergence data. With this, the traveling resistance value and the drive power value with low reliability are prevented from being considered in detecting the submergence data.

In the first embodiment, in addition to a method that simply excludes data corresponding to the reliability degradation state, a method that suppresses the influence of the traveling resistance value and the drive power value calculated from data corresponding to the reliability degradation state on the detection of the submergence data by multiplying data corresponding to the reliability degradation state by a small weight is also considered. More specifically, for example, when determination is made that submergence occurs in a case where a predetermined number or more of pieces of data smaller than the determination acceleration are detected, a method that counts one piece of data in the normal state, not in the reliability degradation state, as one, and counts data corresponding to the reliability degradation state as a value smaller than one, for example, 0.5, thereby suppressing the influence of data corresponding to the reliability degradation state can be used.

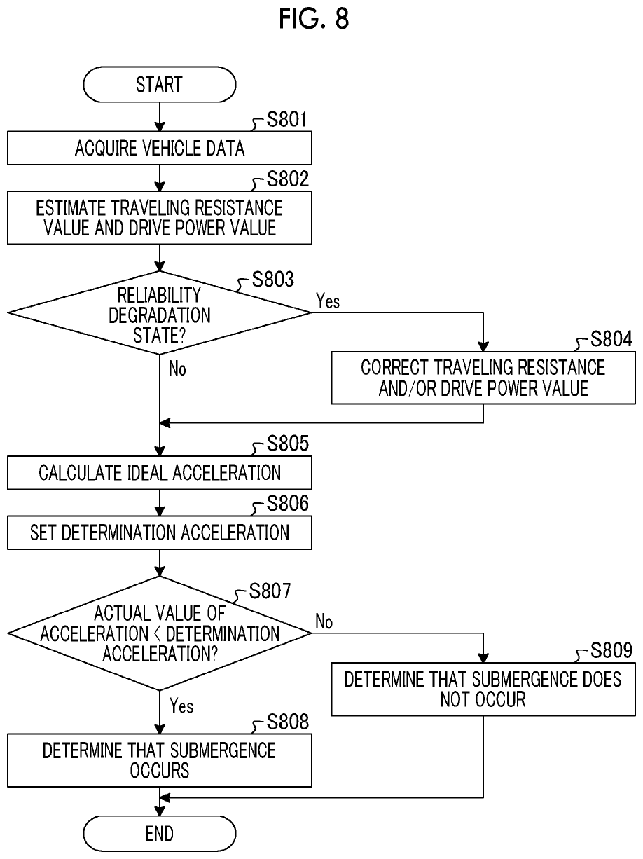

Based on the above configuration, the server device 120 according to the first embodiment detects the submergence data while adjusting the detection method of the submergence data as needed along a flow shown in one of FIGS. 8 to 10 described below.

FIG. 8 is an exemplary flowchart showing an example of a series of processing that can be executed to detect the submergence data according to the first embodiment.

A series of processing shown in FIG. 8 can be executed when the above-described first method is used as the adjustment method of the detection method of the submergence data.

In a series of processing shown in FIG. 8, first, in Step S801, the vehicle data receiver 121 of the server device 120 acquires the vehicle data transmitted from the vehicle 110.

Then, in Step S802, the submergence data detection unit 122 of the server device 120 estimates the traveling resistance value indicating the traveling resistance applied to the vehicle 110 and the drive power value indicating the drive power generated from the drive source of the vehicle 110 based on the above-described estimation data in the vehicle data acquired in Step S801.

Then, in Step S803, the submergence data detection unit 122 of the server device 120 determines whether or not the traveling state of the vehicle 110 corresponds to the reliability degradation state based on the above-described determination data in the vehicle data acquired in Step S801.

In Step S803, when determination is made that the traveling state of the vehicle 110 corresponds to the reliability degradation state, the process progresses to Step S804. Then, in Step S804, the submergence data detection unit 122 of the server device 120 corrects at least one of the traveling resistance value and the drive power value acquired in S802 using the above-described first method.

When the processing of Step S804 is completed, the process progresses to Step S805. When determination is made in Step S803 that the traveling state of the vehicle 110 does not correspond to the reliability degradation state, the process also progresses to Step S805.

Then, in Step S805, the submergence data detection unit 122 of the server device 120 calculates an ideal acceleration as a calculated value of the acceleration of the vehicle 110 in an ideal state with no submergence from the traveling resistance value and the drive power value. In this case, the traveling resistance value and the drive power value are different according to whether or not the processing of Step S804 is executed.

Then, in Step S806, the submergence data detection unit 122 of the server device 120 sets a determination acceleration according to the ideal acceleration calculated in Step S805. As described above, the determination acceleration is a value smaller by a predetermined acceleration corresponding to water resistance than the ideal acceleration.

Then, in Step S807, the submergence data detection unit 122 of the server device 120 determines whether or not the actual value of the acceleration of the vehicle 110 is smaller than the determination acceleration calculated in S806.

When determination is made in Step S807 that the actual value of the acceleration is smaller than the determination acceleration, the process progresses to Step S808. Then, in Step S808, the submergence data detection unit 122 of the server device 120 determines that submergence occurs.

On the other hand, when determination is made in Step S807 that the actual value of the acceleration is equal to or greater than the determination acceleration, the process progresses to Step S809. Then, in Step S809, the submergence data detection unit 122 of the server device 120 determines that submergence does not occur.

The submergence data indicating a determination result in Step S808 or Step S809 is classified for each area according to the position data acquired along with the vehicle data in Step S801, and then, is provided to each area. Then, the process ends.

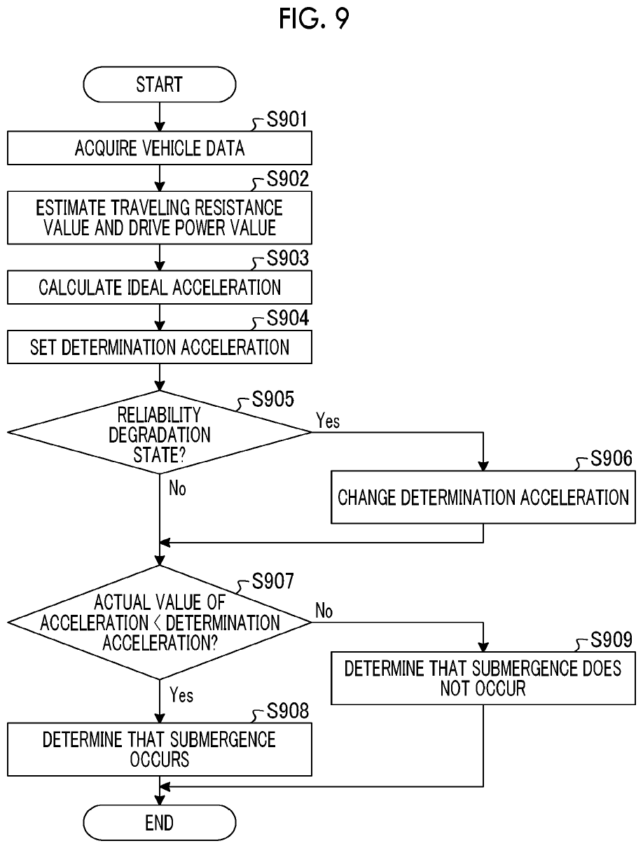

FIG. 9 is an exemplary flowchart showing an example, different from FIG. 8, of a series of processing that can be executed to detect the submergence data according to the first embodiment.

A series of processing shown in FIG. 9 can be executed when the above-described second method is used as the adjustment method of the detection method of the submergence data.

In a series of processing shown in FIG. 9, first, in Step S901, the vehicle data receiver 121 of the server device 120 acquires the vehicle data transmitted from the vehicle 110.

Then, in Step S902, the submergence data detection unit 122 of the server device 120 estimates the traveling resistance value indicating the traveling resistance applied to the vehicle 110 and the drive power value indicating the drive power generated from the drive source of the vehicle 110 based on the estimation data in the vehicle data acquired in Step S901.

Then, in Step S903, the submergence data detection unit 122 of the server device 120 calculates an ideal acceleration from the traveling resistance value and the drive power value acquired in Step S802.

Then, in Step S904, the submergence data detection unit 122 of the server device 120 sets a determination acceleration according to the ideal acceleration calculated in Step S903.

Then, in Step S905, the submergence data detection unit 122 of the server device 120 determines whether or not the traveling state of the vehicle 110 corresponds to the reliability degradation state based on the determination data in the vehicle data acquired in Step S901.

In Step S905, when determination is made that the traveling state of the vehicle 110 corresponds to the reliability degradation state, the process progresses to Step S906. Then, in Step S906, the submergence data detection unit 122 of the server device 120 changes the determination acceleration set in S904 using the above-described second method.

When the processing of Step S906 is completed, the process progresses to Step S907. When determination is made in Step S905 that the traveling state of the vehicle 110 does not correspond to the reliability degradation state, the process also progresses to Step S907.

Then, in Step S907, the submergence data detection unit 122 of the server device 120 determines whether or not the actual value of the acceleration of the vehicle 110 is smaller than the determination acceleration. In this case, the determination acceleration is different according to whether or not the processing of S906 is executed.

When determination is made in Step S907 that the actual value of the acceleration is smaller than the determination acceleration, the process progresses to Step S908. Then, in Step S908, the submergence data detection unit 122 of the server device 120 determines that submergence occurs.

On the other hand, when determination is made in Step S907 that the actual value of the acceleration is equal to or greater than the determination acceleration, the process progresses to Step S909. Then, in Step S909, the submergence data detection unit 122 of the server device 120 determines that submergence does not occur.

The submergence data indicating a determination result in Step S908 or Step S909 is classified for each area according to the position data acquired along with the vehicle data in Step S901, and then, is provided to each area. Then, the process ends.

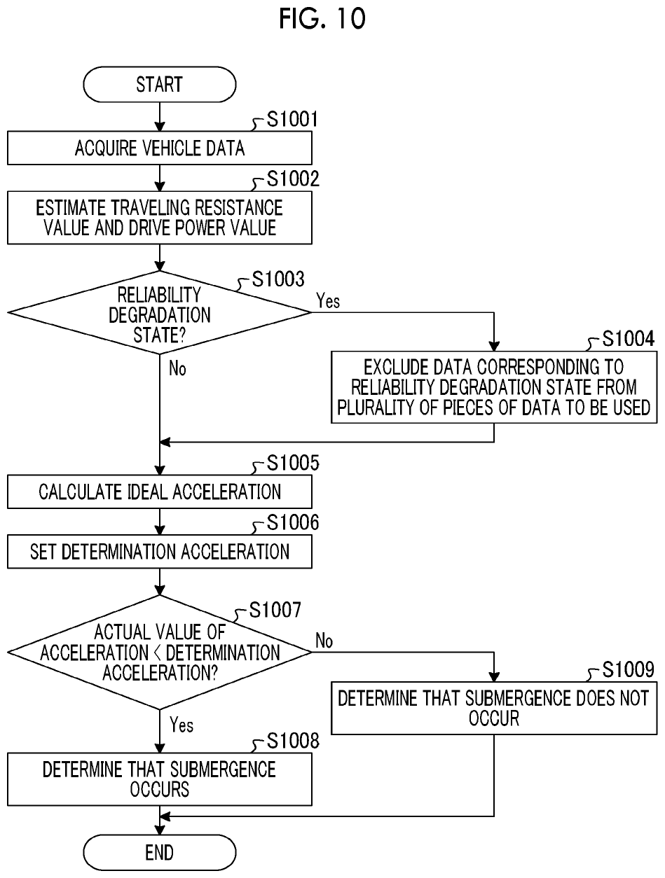

FIG. 10 is an exemplary flowchart showing an example, different from FIGS. 8 and 9, of a series of processing that can be executed to detect the submergence data according to the first embodiment.

A series of processing shown in FIG. 10 can be executed when the above-described third method is used as the adjustment method of the detection method of the submergence data.

In a series of processing shown in FIG. 10, first, in Step S1001, the vehicle data receiver 121 of the server device 120 acquires the vehicle data transmitted from the vehicle 110.

Then, in Step S1002, the submergence data detection unit 122 of the server device 120 estimates a plurality of traveling resistance values indicating the traveling resistance applied to the vehicle 110 and a plurality of drive power values indicating the drive power generated from the drive source of the vehicle 110 based on the estimation data in the vehicle data acquired in Step S901.

Then, in Step S1003, the submergence data detection unit 122 of the server device 120 determines whether or not the traveling state of the vehicle 110 corresponds to the reliability degradation state based on the determination data in the vehicle data acquired in Step S1001.

When determination is made in Step S1003 that the traveling state of the vehicle 110 corresponds to the reliability degradation state, the process progresses to Step S1004. Then, in Step S1004, the submergence data detection unit 122 of the server device 120 excludes data corresponding to the reliability degradation state among a plurality of pieces of data indicating the traveling resistance value and the drive power value estimated in S1002 from a plurality of pieces of data to be used in detecting the submergence data using the above-described third method.

When the processing of Step S1004 is completed, the process progresses to Step S1005. When determination is made in Step S1003 that the traveling state of the vehicle 110 does not correspond to the reliability degradation state, the process also progresses to Step S1005.

Then, in Step S1005, the submergence data detection unit 122 of the server device 120 calculates an ideal acceleration from the pieces of data indicating the traveling resistance value and the drive power value. In this case, the contents of the pieces of data indicating the traveling resistance value and the drive power value are different according to whether or not the processing of S1004 is executed.

Then, in Step S1006, the submergence data detection unit 122 of the server device 120 sets a determination acceleration according to the ideal acceleration calculated in Step S1005.

Then, in Step S1007, the submergence data detection unit 122 of the server device 120 determines whether or not the actual value of the acceleration of the vehicle 110 is smaller than the determination acceleration.

When determination is made in Step S1007 that the actual value of the acceleration is smaller than the determination acceleration, the process progresses to Step S1008. Then, in Step S1008, the submergence data detection unit 122 of the server device 120 determines that submergence occurs.

On the other hand, when determination is made in Step S1007 that the actual value of the acceleration is equal to or greater than the determination acceleration, the process progresses to Step S1009. Then, in Step S1009, the submergence data detection unit 122 of the server device 120 determines that submergence does not occur.

The submergence data indicating a determination result in Step S1008 or Step S1009 is classified for each area according to the position data acquired along with the vehicle data in Step S1001, and then, is provided to each area. Then, the process ends.

As described above, the submergence data provision system according to the first embodiment includes the server device 120 that functions as a submergence data detection device and also functions as a submergence data provision device. The server device 120 includes the vehicle data receiver 121, the submergence data detection unit 122, and the submergence data provision unit 123.

The vehicle data receiver 121 acquires the vehicle data that includes at least the acceleration data indicating the actual value of the acceleration of the vehicle 110 traveling on the road surface and the estimation data for acquiring the drive power value indicating the estimated value of the drive power generated from the drive source of the vehicle 110 and the traveling resistance value indicating the estimated value of the traveling resistance applied to the vehicle 110, and indicates the traveling state of the vehicle 110. Then, the submergence data detection unit 122 detects the submergence data indicating the state of submergence of the road surface, on which the vehicle 110 travels, based on the vehicle data by the detection method including comparison of the threshold value set according to the calculated value of the acceleration of the vehicle 110 calculated from the drive power value and the traveling resistance value with the actual value of the acceleration of the vehicle 110. In this case, the submergence data detection unit 122 adjusts the detection method according to whether or not the traveling state indicated by the vehicle data corresponds to the reliability degradation state, in which the reliability of the calculated value of the acceleration of the vehicle 110 is degraded, such that the detection accuracy of the submergence data in the reliability degradation state is improved. Then, the submergence data provision unit 123 provides the submergence data detected by the submergence data detection unit 122 to the outside.

With the submergence data provision system according to the first embodiment, the submergence data is detected by the detection method appropriately adjusted according to the traveling state of the vehicle 110 such that the detection accuracy of the submergence data is improved, whereby it is possible to obtain the submergence data with high accuracy. Then, it is possible to provide the submergence data with high accuracy to the outside.

In the first embodiment, the vehicle data receiver 121 acquires the determination data including at least one of the feature of the road surface, the change amount per predetermined time of the acceleration, the operation state of the drive source, the steering angle of the vehicle 110, the air pressure of the wheels of the vehicle 110, weather, and the weight of the vehicle 110 as the vehicle data to be a criterion for determining whether or not the traveling state corresponds to the reliability degradation state. Then, the submergence data detection unit 122 determines whether or not the traveling state corresponds to the reliability degradation state based on the determination data. According to such a configuration, focusing on the determination data related to a factor causing divergence between the actual value of the drive power and the drive power value or divergence between the actual value of the traveling resistance and the traveling resistance value, it is possible to appropriately perform determination regarding whether or not the reliability of the calculated value of the acceleration of the vehicle is degraded.

For example, in the first embodiment, the vehicle data receiver 121 can acquire, as the determination data, at least data indicating the change amount per predetermined time of the acceleration. In this case, the submergence data detection unit 122 can determine that the traveling state corresponds to the reliability degradation state when the change amount per predetermined time of the acceleration is greater than the predetermined amount, and can adjust the detection method so as to suppress the divergence between the actual value of the drive power and the drive power value according to a determination result (see FIGS. 3 and 4). According to such a configuration, focusing on the change amount per predetermined time of the acceleration related to the factor causing the divergence between the actual value of the drive power and the drive power value, it is possible to appropriately perform determination regarding whether or not the reliability of the calculated value of the acceleration of the vehicle 110 is degraded, and to appropriately suppress the divergence between the actual value of the drive power and the drive power value.

In the first embodiment, the vehicle data receiver 121 can acquire, as the determination data, at least data indicating the steering angle of the vehicle 110. In this case, the submergence data detection unit 122 can determine that the traveling state corresponds to the reliability degradation state when the steering angle of the vehicle 110 is greater than the predetermined angle, and can adjust the detection method so as to suppress the divergence between the actual value of the traveling resistance and the traveling resistance value according to a determination result (see FIG. 5). According to such a configuration, focusing on the steering angle of the vehicle 110 related to the factor causing the divergence between the actual value of the traveling resistance and the traveling resistance value, it is possible to appropriately perform determination regarding whether or not the reliability of the calculated value of the acceleration of the vehicle 110 is degraded, and to appropriately suppress the divergence between the actual value of the traveling resistance and the traveling resistance value.

Here, in the first embodiment, the submergence data detection unit 122 can adjust the detection method of the submergence data by correcting at least one of the traveling resistance value and the drive power value using the above-described first method when the traveling state corresponds to the reliability degradation state. According to such a configuration, at least one of the traveling resistance value and the drive power value to be a source of the calculated value of the acceleration for setting the threshold value for comparison with the actual value of the acceleration is corrected, whereby it is possible to easily adjust the detection method such that the detection accuracy of the submergence data is improved.

In the first embodiment, the submergence data detection unit 122 can adjust the detection method of the submergence data by changing the setting method of the threshold value for comparison with the actual value of the acceleration of the vehicle 110 using the above-described second method when the traveling state corresponds to the reliability degradation state. According to such a configuration, the setting method of the threshold value for comparison with the actual value of the acceleration is changed, whereby it is possible to easily adjust the detection method such that the detection accuracy of the submergence data is improved.

In the first embodiment, the submergence data detection unit 122 can adjust the detection method of the submergence data using the above-described third method when the submergence data is detected by the detection method including comparison of a plurality of threshold values set according to a plurality of calculated values of the acceleration of the vehicle 110 with a plurality of actual values of the acceleration of the vehicle 110. More specifically, the submergence data detection unit 122 sets the influence on the detection of the submergence data of the traveling resistance value and the drive power value calculated when the traveling state corresponds to the reliability degradation state to be smaller than the influence on the detection of the submergence data of the traveling resistance value and the drive power value calculated when the traveling state corresponds to the normal state different from the reliability degradation state, thereby adjusting the detection method. According to such a configuration, the influence of data with low reliability among a plurality of pieces of data to be a source of the calculated values of the acceleration of the vehicle 110 on the detection of the submergence data is set to be small, whereby it is possible to easily adjust the detection method such that the detection accuracy of the submergence data is improved.

In the first embodiment, the submergence data provision unit 133 provides the submergence data classified for each region on the road surface according to the position data. According to such a configuration, it is possible to provide the appropriately classified submergence data with high accuracy to the outside.

### Second Embodiment

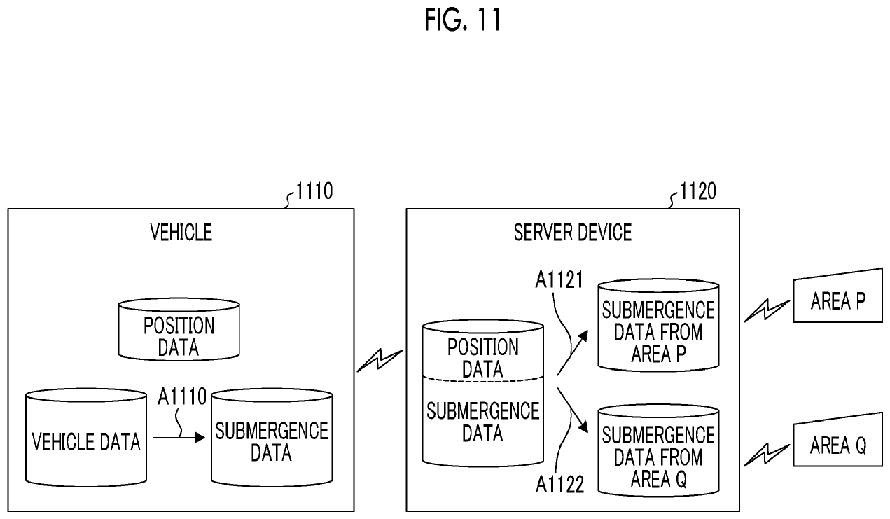

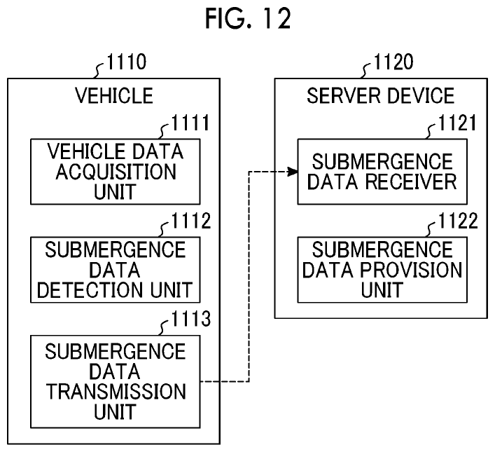

In the above-described first embodiment, a configuration in which the detection of the submergence data is executed by the server device 120, not the vehicle 110, is exemplified (see FIGS. 1 and 2). However, as a second embodiment, a configuration in which the detection of the submergence data is executed by the vehicle 1110 in a form shown in FIGS. 11 and 12 described below is also considered.

FIG. 11 is an exemplary and schematic block diagram illustrating a flow of data in a submergence data provision system according to the second embodiment.

As shown in FIG. 11, the submergence data provision system according to the second embodiment includes a vehicle 1110 and a server device 1120. The vehicle 1110 is an example of a “submergence data detection device”, and the server device 1120 is an example of a “submergence data provision device”.

In the second embodiment, the vehicle 1110 detects submergence data based on vehicle data indicating a traveling state of the vehicle 1110 (see an arrow A1110). Then, the vehicle 1110 transmits the submergence data to the server device 1120 along with position data indicating a position of the vehicle 1110 on a road surface. A detection method of the submergence data is the same as in the above-described first embodiment.

Then, in the second embodiment, the server device 1120 associates the submergence data received from the vehicle 1110 with the position data. Then, the server device 1120 classifies the submergence data, for example, for each area according to the position data (see arrows A1121 and A1122). Then, the server device 1120 provides the classified submergence data to the outside, such as a company of a corresponding area.

A flow of data described above can be implemented by providing functions shown in subsequent FIG. 12 in the vehicle 1110 and the server device 1120.

FIG. 12 is an exemplary and schematic block diagram showing functions of the vehicle 1110 and the server device 1120 according to the second embodiment.

As shown in FIG. 12, the vehicle 1110 includes a vehicle data acquisition unit 1111, a submergence data detection unit 1112, and a submergence data transmission unit 1113, and the server device 1120 includes a submergence data receiver 1121 and a submergence data provision unit 1122. The submergence data receiver 1121 is an example of a “submergence data acquisition unit”.

The vehicle data acquisition unit 1111 acquires the vehicle data. Then, the submergence data detection unit 1112 detects the submergence data based on the vehicle data by the same detection method as in the above-described first embodiment while appropriately adjusting the detection method using the same method as in the above-described first embodiment as needed. Then, the submergence data transmission unit 1113 transmits the submergence data to the server device 1120 along with the position data.

The submergence data receiver 1121 receives the submergence data transmitted along with the position data from the submergence data transmission unit 1113. Then, the submergence data provision unit 123 classifies the submergence data, for example, for each area according to the position data, and then, provides the submergence data to the outside. For example, the submergence data provision unit 123 extracts submergence data included in a predetermined position area and provides the submergence data as submergence data of a predetermined area.

The second embodiment is the same as the above-described first embodiment excluding that a subject of the detection of the submergence data is the vehicle 1110. Accordingly, with the second embodiment, it is also possible to obtain the same effects as in the above-described first embodiment.

### Third Embodiment

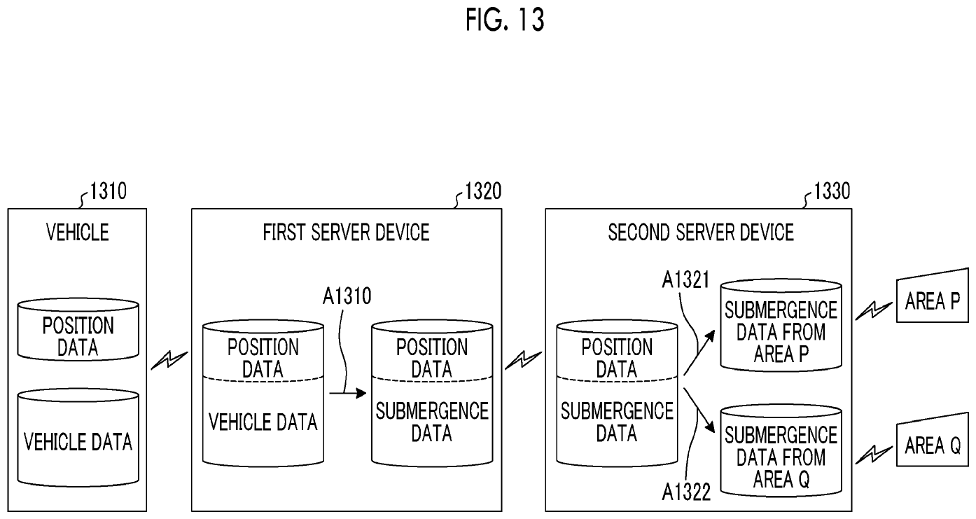

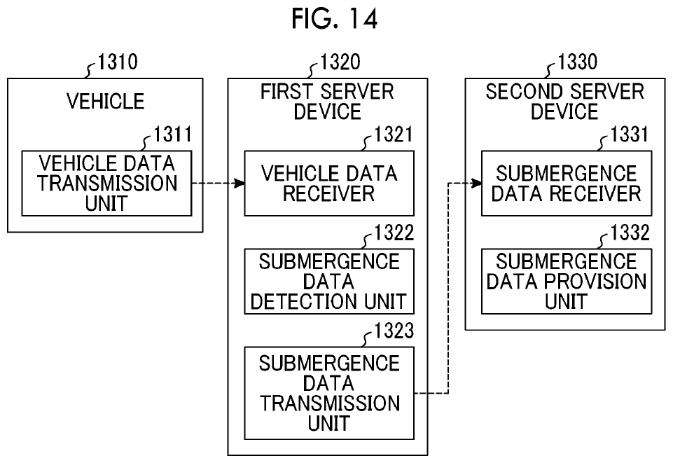

In the above-described first embodiment, a configuration in which both of the detection and the provision of the submergence data are executed by the single server device 120 is exemplified (see FIGS. 1 and 2). However, as a third embodiment, a configuration in which the detection and the provision of the submergence data are shared by two server devices (a first server device 1320 and a second server device 1330) in a form shown in FIGS. 13 and 14 described below is also considered.

FIG. 13 is an exemplary and schematic block diagram illustrating a flow of data in a submergence data provision system according to the third embodiment.

As shown in FIG. 13, the submergence data provision system according to the third embodiment includes a vehicle 1310, the first server device 1320, and the second server device 1330. The first server device 1320 is an example of a “submergence data detection device”, and the second server device 1330 is an example of a “submergence data provision device”.

In the third embodiment, the vehicle 1310 transmits vehicle data indicating a traveling state of the vehicle 1310 to the first server device 1320 along with position data indicating a position of the vehicle 1310 on a road surface.

Then, in the third embodiment, the first server device 1320 detects the submergence data based on the vehicle data received from the vehicle 1310 (see an arrow A1310). In this case, the first server device 1320 associates the position data with the vehicle data, and associates the position data with the submergence data. The first server device 1320 transmits the submergence data associated with the position data to the second server device 1330. A detection method of the submergence data is the same as in the above-described first embodiment.

Then, in the third embodiment, the second server device 1330 classifies the submergence data received from the first server device 1320, for example, for each area according to the position data (see arrows A1321 and A1322). Then, the second server device 1330 provides the classified submergence data to the outside, such as a company of a corresponding area.

A flow of data described above can be implemented by providing functions shown in subsequent FIG. 14 in the vehicle 1310, the first server device 1320, and the second server device 1330.

FIG. 14 is an exemplary and schematic block diagram showing functions of the vehicle 1310, the first server device 1320, and the second server device 1330 according to the third embodiment.

As shown in FIG. 14, the vehicle 1310 includes a vehicle data transmission unit 1311. The first server device 1320 includes a vehicle data receiver 1321, a submergence data detection unit 1322, and a submergence data transmission unit 1323, and the second server device 1330 includes a submergence data receiver 1331 and a submergence data provision unit 1332. The vehicle data receiver 1321 is an example of a “vehicle data acquisition unit”, and the submergence data receiver 1331 is an example of a “submergence data acquisition unit”.

The vehicle data transmission unit 1311 transmits the vehicle data to the first server device 1320 along with the position data.

Then, the vehicle data receiver 1321 receives the vehicle data transmitted from the vehicle data transmission unit 1311. Then, the submergence data detection unit 1322 detects the submergence data based on the vehicle data received by the vehicle data receiver 1321 by the same detection method as in the above-described first embodiment while adjusting the detection method using the same method as in the above-described first embodiment as needed. Then, the submergence data transmission unit 1323 transmits the submergence data to the second server device 1330 along with the position data.

Then, the submergence data receiver 1331 receives the submergence data transmitted along with the position data from the submergence data transmission unit 1323. Then, the submergence data provision unit 1332 classifies the submergence data according to the position data and provides the submergence data to the outside.

The third embodiment is the same as the first embodiment excluding that the detection and the provision of the submergence data are shared by the first server device 1320 and the second server device 1330. Accordingly, with the third embodiment, it is also possible to obtain the same effects as in the above-described first embodiment.

### Fourth Embodiment

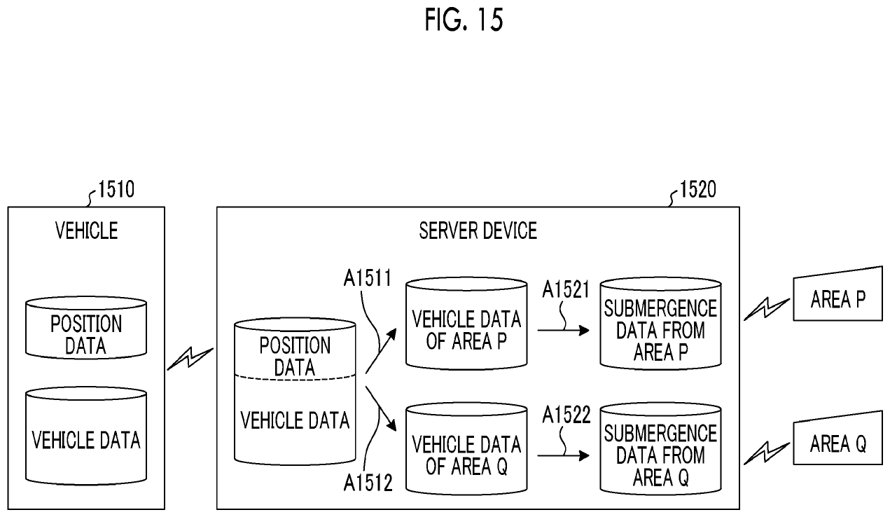

In the above-described first embodiment, a configuration in which the classification according to the position data is executed at a stage after the submergence data is detected is exemplified (see FIGS. 1 and 2). However, as a fourth embodiment, a configuration in which the classification according to the position data is executed in a form shown in subsequent FIG. 15 at a stage before the submergence data is detected, more specifically, at a stage after vehicle data to be a source of the submergence data is acquired is also considered.

FIG. 14 is an exemplary and schematic block diagram illustrating a flow of data in a submergence data provision system according to the fourth embodiment.

As shown in FIG. 14, the submergence data provision system according to the fourth embodiment includes a vehicle 1410 and a server device 1420. The server device 1420 is an example of a “submergence data detection device”, and is also an example of a “submergence data provision device”.

In the fourth embodiment, the vehicle 1510 transmits vehicle data indicating a traveling state of the vehicle 1510 to the server device 1520 along with position data indicating a position of the vehicle 1510 on a road surface.

Then, in the fourth embodiment, the server device 1520 associates the vehicle data and the position data received from the vehicle 1310, and then, classifies the vehicle data, for example, for each area according to the position data (see an arrow A1511). Then, the server device 1520 detects, based on the vehicle data, the submergence data classified in the same manner as the vehicle data (see arrows A1521 and A1522). Then, the second server device 1330 provides the classified submergence data to the outside, such as a company of a corresponding area. A detection method of the submergence data is the same as in the above-described first embodiment.

Functions to be provided in the vehicle 1510 and the server device 1520 in order to implement a flow of data described above are substantially the same as those in the above-described first embodiment (see FIG. 2), and thus, description thereof will not be repeated.

The fourth embodiment is the same as the above-described first embodiment excluding that the classification according to the position data is executed for the vehicle data, not the submergence data. Accordingly, with the fourth embodiment, it is also possible to obtain the same effects as in the above-described first embodiment.

### Hardware Configuration for Implementing Functions of First to Fourth Embodiments

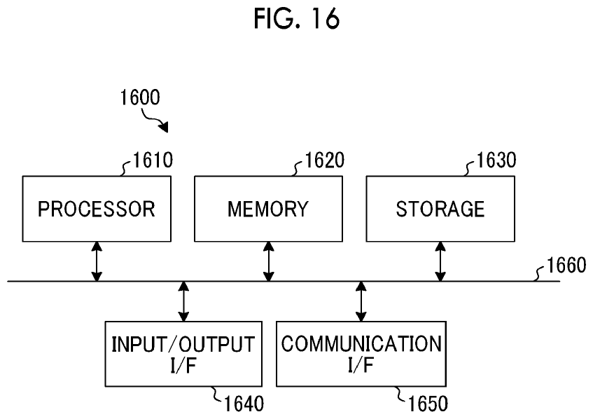

The functions of the above-described first to fourth embodiments shown in FIGS. 2, 12, 14, and the like can be implemented by an information processing device 1600 shown in subsequent FIG. 16 including the same hardware resources as a normal computer.

FIG. 16 is an exemplary and schematic diagram showing the hardware configuration of the information processing device 1600 for implementing the functions of the first to fourth embodiments.

As shown in FIG. 16, the information processing device 1600 according to an embodiment includes a processor 1610, a memory 1620, a storage 1630, an input/output interface (I/F) 1640, and a communication interface (I/F) 1650. The hardware units are connected to a bus 1660.

The processor 1610 is constituted as, for example, a central processing unit (CPU), and integrally controls the operations of the respective units of the information processing device 1600. The memory 1620 includes, for example, a read only memory (ROM) and a random access memory (RAM), and implements volatile or nonvolatile storage of various kinds of data, such as programs that are executed by the processor 1610, provision of a work area where the processor 1610 executes a program, and the like.

The storage 1630 includes, for example, a hard disk drive (HDD) or a solid state drive (SSD), and stores various kinds of data in a nonvolatile manner. The input/output interface 1640 controls an input of data to the information processing device 1600 and an output of data from the information processing device 1600. The communication interface 1650 enables the information processing device 1600 to execute communication with other devices through a network, such as the Internet.

The functions (see FIGS. 2, 12, 14, and the like) of the above-described first to fourth embodiments are functionally implemented as a result of the processor 1610 of the information processing device 1600 to be the respective components of the submergence data provision system executing various programs, such as a submergence data detection program stored in the memory 1620 or the storage 1630. However, in the embodiment, at least a part of the functions (see FIGS. 2, 12, 14, and the like) of the above-described first to fourth embodiments may be implemented as dedicated hardware (circuit).

Various programs that are executed in the information processing device 1600 according to the embodiment may be provided in a state incorporated into a storage device, such as the memory 1620 and the storage 1630, or may be provided as a computer program product recorded in an installable or executable format on a computer-readable non-transitory recording medium, for example, various magnetic disks, such as a flexible disk (FD), and various optical disks, such as a digital versatile disk (DVD).

Various programs that are executed in the embodiment may be provided or distributed by way of a network, such as the Internet. That is, various programs that are executed in the embodiment may be provided in a form of being downloaded from a computer by way of the network, such as the Internet, in a state stored on the computer connected to the network. Similarly, various learned models that are used in the embodiment may be provided or distributed by way of the network, such as the Internet.

Although several embodiments of the present disclosure have been described above, the above-described embodiments are merely examples, and thus, are not intended to limit the scope of the disclosure. The above-described new embodiments can be carried out in various forms, and various omissions, replacements, and alterations may be made without departing from the spirit and scope of the disclosure. The above-described embodiments and modifications thereof are included in the disclosures disclosed in the claims and equivalents thereof as included in the scope and the spirit of the disclosure.

What is claimed is:

1. A submergence data detection device comprising:
a vehicle data acquisition unit configured to acquire vehicle data, which includes at least acceleration data indicating an actual value of an acceleration of a vehicle traveling on a road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle; and
a submergence data detection unit configured to detect submergence data indicating a state of submergence of the road surface, on which the vehicle travels, based on the vehicle data by a detection method including comparison of a threshold value set according to a calculated value of the acceleration of the vehicle calculated from the drive power value and the traveling resistance value with the actual value of the acceleration of the vehicle, and adjust the detection method according to whether or not the traveling state indicated by the vehicle data corresponds to a first state, in which reliability of the calculated value of the acceleration of the vehicle is degraded, such that detection accuracy of the submergence data in the first state is improved.

2. The submergence data detection device according to claim 1, wherein:
the vehicle data acquisition unit is configured to acquire, as the vehicle data to be a criterion for determining whether or not the traveling state corresponds to the first state, determination data including at least one of a feature of the road surface, a change amount per predetermined time of the acceleration, an operation state of the drive source, a steering angle of the vehicle, air pressure of wheels of the vehicle, weather, and a weight of the vehicle; and
the submergence data detection unit is configured to determine whether or not the traveling state corresponds to the first state based on the determination data.

3. The submergence data detection device according to claim 2, wherein:
the vehicle data acquisition unit is configured to acquire, as the determination data, at least data indicating the change amount per predetermined time of the acceleration; and
the submergence data detection unit is configured to determine that the traveling state corresponds to the first state when the change amount is greater than a predetermined amount and adjust the detection method so as to suppress divergence between an actual value of the drive power and the drive power value according to a determination result.

4. The submergence data detection device according to claim 2, wherein:
the vehicle data acquisition unit is configured to acquire, as the determination data, at least data indicating the steering angle of the vehicle; and
the submergence data detection unit is configured to determine that the traveling state corresponds to the first state when the steering angle of the vehicle is greater than a predetermined angle and adjust the detection method so as to suppress divergence between an actual value of the traveling resistance and the traveling resistance value according to a determination result.

5. The submergence data detection device according to claim 1, wherein the submergence data detection unit is configured to adjust the detection method by correcting at least one value of the traveling resistance value and the drive power value when the traveling state corresponds to the first state.

6. The submergence data detection device according to claim 1, wherein the submergence data detection unit is configured to adjust the detection method by changing a setting method of the threshold value compared with the actual value of the acceleration of the vehicle when the traveling state corresponds to the first state.

7. The submergence data detection device according to claim 1, wherein the submergence data detection unit is configured to, when the submergence data is detected by the detection method including the comparison of a plurality of threshold values set according to a plurality of calculated values of the acceleration with a plurality of actual values of the acceleration, adjust the detection method by setting an influence on the detection of the submergence data of the traveling resistance value and the drive power value calculated when the traveling state corresponds to the first state to be smaller than an influence on the detection of the submergence data of the traveling resistance value and the drive power value calculated when the traveling state corresponds to a second state different from the first state.

8. A submergence data detection method comprising:
acquiring vehicle data, which includes at least acceleration data indicating an actual value of an acceleration of a vehicle traveling on a road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle; and
detecting submergence data indicating a state of submergence of the road surface, on which the vehicle travels, based on the vehicle data by a detection method including comparison of a threshold value set according to a calculated value of the acceleration of the vehicle calculated from the drive power value and the traveling resistance value with the actual value of the acceleration of the vehicle, and adjusting the detection method according to whether or not the traveling state indicated by the vehicle data corresponds to a first state, in which reliability of the calculated value of the acceleration of the vehicle is degraded, such that detection accuracy of the submergence data in the first state is improved.

9. A non-transitory storage medium storing instructions that are executable by one or more processors and that cause the one or more processors to perform functions comprising:
acquiring vehicle data, which includes at least acceleration data indicating an actual value of an acceleration of a vehicle traveling on a road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle; and
detecting submergence data indicating a state of submergence of the road surface, on which the vehicle travels, based on the vehicle data by a detection method including comparison of a threshold value set according to a calculated value of the acceleration of the vehicle calculated from the drive power value and the traveling resistance value with the actual value of the acceleration of the vehicle, and adjusting the detection method according to whether or not the traveling state indicated by the vehicle data corresponds to a first state, in which reliability of the calculated value of the acceleration of the vehicle is degraded, such that detection accuracy of the submergence data in the first state is improved.

10. A submergence data provision system comprising:
a vehicle data acquisition unit configured to acquire vehicle data, which includes at least acceleration data indicating an actual value of an acceleration of a vehicle traveling on a road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle;
a submergence data detection unit configured to detect submergence data indicating a state of submergence of the road surface, on which the vehicle travels, based on the vehicle data by a detection method including comparison of a threshold value set according to a calculated value of the acceleration of the vehicle calculated from the drive power value and the traveling resistance value with the actual value of the acceleration of the vehicle, and adjust the detection method according to whether or not the traveling state indicated by the vehicle data corresponds to a first state, in which reliability of the calculated value of the acceleration of the vehicle is degraded, such that detection accuracy of the submergence data in the first state is improved; and
a submergence data provision unit configured to provide the submergence data detected by the submergence data detection unit to the outside.

11. The submergence data provision system according to claim 10, wherein:
the vehicle data acquisition unit is configured to acquire the vehicle data along with position data indicating a position of the vehicle on the road surface corresponding to the vehicle data;
the submergence data detection unit is configured to detect the submergence data while associating the submergence data with the position data; and
the submergence data provision unit is configured to provide the submergence data classified for each region on the road surface according to the position data.

12. The submergence data provision system according to claim 10, wherein:
the vehicle data acquisition unit is configured to acquire the vehicle data along with position data indicating a position of the vehicle on the road surface corresponding to the vehicle data;
the submergence data detection unit is configured to detect the submergence data classified for each region on the road surface based on the vehicle data classified for each region on the road surface according to the position data; and
the submergence data provision unit is configured to provide the submergence data classified for each region on the road surface.

13. A submergence data provision device comprising:
a submergence data acquisition unit configured to acquire submergence data detected by a submergence data detection unit configured to detect the submergence data indicating a state of submergence of a road surface, on which a vehicle travels, based on vehicle data, which includes at least acceleration data indicating an actual value of an acceleration of the vehicle traveling on the road surface and estimation data for acquiring a drive power value indicating an estimated value of drive power generated from a drive source of the vehicle and a traveling resistance value indicating an estimated value of traveling resistance applied to the vehicle, and indicates a traveling state of the vehicle, by a detection method including comparison of a threshold value set according to a calculated value of the acceleration of the vehicle calculated from the drive power value and the traveling resistance value with the actual value of the acceleration of the vehicle and adjust the detection method according to whether or not the traveling state indicated by the vehicle data corresponds to a first state, in which reliability of the calculated value of the acceleration of the vehicle is degraded, such that detection accuracy of the submergence data in the first state is improved; and
a submergence data provision unit configured to provide the submergence data acquired by the submergence data acquisition unit to the outside.
